(19) United States
(12) Patent Application Publication
(10) Pub. No.: US 2025/0266923 A1
(43) Pub. Date: Aug. 21, 2025

(54) METHOD FOR WIRELESS AND FRONTHAUL SCHEDULING TO SUPPORT COORDINATED MULTIPOINT TRANSMISSION IN 6G AND A SYSTEM THEREOF

(71) Applicant: INDIAN INSTITUTE OF TECHNOLOGY KHARAGPUR, Kharagpur (IN)

(72) Inventors: Preeti Samhita PATI, Kharagpur (IN); Bhandarkar Sourabh SUNIL, Kharagpur (IN); Nikita MUNDU, Kharagpur (IN); Sourav DUTTA, Kharagpur (IN); Goutam DAS, Kharagpur (IN)

(73) Assignee: INDIAN INSTITUTE OF TECHNOLOGY KHARAGPUR, Kharagpur (IN)

(21) Appl. No.: 18/939,256

(22) Filed: Nov. 6, 2024

(30) Foreign Application Priority Data
Feb. 15, 2024 (IN) 202431010696

(51) Int. Cl. H04J 14/02; H04L 5/00

(52) U.S. Cl. CPC H04J 14/0247; H04L 5/0035

(57) ABSTRACT

A method for facilitating Coordinated Multipoint Transmission (COMP) involving joint scheduling of wireless access and Time Wavelength Division Multiplexing-Passive Optical Network (TWDM-PON) based fronthaul for COMP joint transmission comprising identifying dependency of wireless access data rate with the number of Front-Haul (FH) optical wavelengths in the TWDM-PON based Cloud-Radio Access Network (C-RAN) model, maintaining synchronization in the FH while transmitting copies of streams through Coordinated Multipoint Reception (COMP) Remote Radio Heads (RRHs) through respective Optical Network Units (ONUs) by necessary changes in the Multi Point Control Protocol (MPCP) and cycle time modification to achieve faithful reconstruction of signals at the ONU including HARQ retransmissions through modifications in Media Access Control (MAC) layer.

### RELATED APPLICATIONS

This application claims priority to India patent application No. 202431010696, Filing Date Feb. 15, 2024, entitled Method For Wireless And Fronthaul Scheduling To Support Coordinated Multipoint Transmission In 6g And A System Thereof; which is incorporated herein by reference in its entirety.

### FIELD OF THE INVENTION

The present invention relates to improvements in Coordinated Multipoint Transmission (COMP). More specifically, it is directed towards providing a system and method for the joint scheduling of wireless access and TWDM-EPON based fronthaul for COMP joint transmission in 6G networks. The proposed invention introduces changes to the existing protocol for downlink transmission to maintain precise synchronization. Furthermore, the invention proposes a suitable cycle time in scheduling to ensure the delay bound for HARQ transmission in the MAC layer is followed. This method enhances the reliability of existing state-of-the-art COMP technology, allowing URLLC applications to thrive in the next-generation communication ecosystem.

### BACKGROUND OF THE INVENTION

The 3GPP (Generation Partnership Project) group has long ago specified Coordinated Multipoint transmission as a technology for improving the data rate of edge users through transmitting from coordinated base stations on the same resource block. CoMP synchronizes the data transmission among multiple adjacent cells through X2 interface.

Jiawei Zhang; Yuefeng Ji; Songhao Jia; Hui Li; Xiaosong Yu; Xinbo Wang [“Reconfigurable optical mobile fronthaul networks for coordinated multipoint transmission and reception in 5G,” in Journal of Optical Communications and Networking, vol. 9, no. 6, pp. 489-497, June 2017, doi: 10.1364/JOCN.9.000489.] discuss the reconfigurability of TWDM-PON based fronthaul that can improve the COMP service in a C-RAN system through elastic radio resource allocation.

Li-Hsiang Shen; Yung-Ting; Huang; Kai-Ten Feng [“CoMP-Enhanced Flexible Functional Split for Mixed Services in Beyond 5G Wireless Networks,” in IEEE Transactions on Communications, vol. 71, no. 7, pp. 4133-4150 Jul. 2023, doi: 10.1109/TCOMM.2023.3274155.] propose a CoMP-enhanced Functional Split-Mode Allocation (CFSMA) scheme that optimizes system spectrum efficiency while guaranteeing stringent latency requirements in a C-RAN 5G system.

Ahmed Mohammed Mikaeil; Weisheng Hu; Longsheng Li [“Joint Allocation of Radio and Fronthaul Resources in Multi-Wavelength-Enabled C-RAN Based on Reinforcement Learning,” in Journal of Lightwave Technology, vol. 37, no. 23, pp. 5780-5789, 1 Dec.1, 2019, doi: 10.1109/JLT.2019.2939169.] discuss a joint allocation framework for multi-wavelength PONs fronthaul uplink resources.

Jiawei Zhang; Yuming Xiao; Dexue Song; Lin Bai; Yuefeng Ji [“Joint Wavelength, Antenna, and Radio Resource Block Allocation for Massive MIMO Enabled Beamforming in a TWDM-PON Based Fronthaul,” in Journal of Lightwave Technology, vol. 37, no. 4, pp. 1396-1407, 15 Feb.15, 2019, doi: 10.1109/JLT.2019.2894152.] discuss a joint allocation framework for multi-wavelength PONs fronthaul uplink resources.

Gustavo B. Figueiredo; Xinbo Wang; Carlos Colman Meixner; Massimo Tornatore; Biswanath Mukherjee [“Load balancing and latency reduction in multi-user COMP over TWDM-VPONs,” 2016 IEEE International Conference on Communications (ICC), Kuala Lumpur, Malaysia, 2016, pp. 1-6, doi: 10.1109/ICC.2016.7511477.] propose a new architecture for supporting COMP operations in emerging cellular systems. It is based on a time-and-wavelength-division-multiplexed passive optical network (TWDM-PON) fronthaul, using virtualized base stations and a cloud radio access network (C-RAN) architecture.

WO2020221430A1 discloses a method and apparatus for controlling transmission of an upstream packet traffic in a tdm pon-based fronthaul.

However, with the centralization of next-generation networks, the centralized units do heavy processing and lower physical layer functionalities are performed at base stations or the Remote Radio Heads (RRHs). This demands a higher bandwidth fronthaul link. However, this introduces the challenge of synchronization for COMP coordination in the downlink. The fronthaul link could be of TWDM-EPON. Again, this poses challenges in terms of number of wavelengths available for scheduling and time slot coordination while scheduling. Hence, there has been a need addressing these challenges with a novel system and method.

### OBJECT OF THE INVENTION

It is thus basic object of the present invention is to develop a system and method for joint scheduling of wireless access and TWDM-EPON based fronthaul for COMP joint transmission in 6G networks enhancing the reliability of existing COMP state-of-the-art.

Another objective of the present invention is to create a system and method for joint scheduling of wireless access and TWDM-EPON based fronthaul for COMP joint transmission in 6G networks, which introduces changes to the existing protocol for downlink transmission to maintain precise synchronization.

A further objective of the present invention is to design a system and method for joint scheduling of wireless access and TWDM-EPON based fronthaul for COMP joint transmission in 6G networks, implementing a suitable cycle time in scheduling to ensure that the stringent delay bound for HARQ transmission in the MAC layer is followed.

### SUMMARY OF THE INVENTION

Thus, according to the basic aspect of the present invention there is provided a method for facilitating Coordinated Multipoint Transmission (COMP) involving joint scheduling of wireless access and Time Wavelength Division Multiplexing-Passive Optical Network (TWDM-PON) based fronthaul for COMP joint transmission comprising
identifying dependency of wireless access data rate with the number of Front-Haul (FH) optical wavelengths in the TWDM-PON based Cloud-Radio Access Network (C-RAN);
maintaining synchronization in the FH while transmitting copies of streams through Coordinated Multipoint Reception (COMP) Remote Radio Heads (RRHs) through respective Optical Network Units (ONUs) by necessary changes in the Multi Point Control Protocol (MPCP);
cycle time modification to achieve faithful reconstruction of signals at the ONU including HARQ retransmissions through modifications in Media Access Control (MAC) layer.

In the above method, the identification of the dependency of wireless access data rate with the number of Front-Haul (FH) optical wavelengths in the TWDM-PON based Cloud-Radio Access Network (C-RAN) model includes involving communication operating between OLT (Optical Line Terminal) and BBU (Base Band Unit) through a control channel at beginning of every polling cycle to decide which users are of an RRH (i.e., ONU) will be allocated with a resource block and at which wavelength and slot the ONU send the downstream data, whereby the OLT ensure that if a user is scheduled, all the ONUs through which it transmits downstream (DS) traffic should be assigned the same slot;
allocating the resource block to the maximum number of scheduled users by the BBU ensuring the same resource block will be allocated to the user in all RRHs through which it transmits downstream (DS) data.

In the above method, the changes in the MPCP with COMP Downlink Scheduling in TWDM-EPON based C-RAN 6G Network includes involving playout buffers at the ONU in order to match with the outgoing rate at eCPRI. providing an additional field in GATE message in existing MPCP protocol to ensure the synchronization of data at the user end in the downlink; wherein the playout buffers in the ONU align their outgoing rate with the incoming rate from the eCPRI/CPRI source resulting a received CPRI basic frame should not be queued for more than the specified delay threshold and a synchronization which help SDN controllers to schedule coordinated multipoint users through different base stations connected through different wavelengths in the same time slot.

In the above method, the modification in Media Access Control (MAC) layer includes providing variable slot scheduling for the ONUs in the downlink to meet stringent requirement on delay bound at the MAC layer involving the OLT to takes a note of the Round Trip Time (RTT) from all the ONUs and noting the maximum delay among all the ONUs which is sent across to all ONUs such as that the ONUs wait for the difference amount of time between worst case delay and their respective synchronized time before initiating their data transmission in the downlink.

The above method is adapted for joint user association, sub-carrier (i.e. RBG) resource allocation and slot allocation through jointly optimized operation.

According to another aspect of the present invention there is provided a system implementing method for facilitating the Coordinated Multipoint Transmission (COMP) involving joint scheduling of wireless access and Time Wavelength Division Multiplexing-Passive Optical Network (TWDM-PON) based fronthaul for COMP joint transmission comprising
said ONUs each having
a playout buffer to enable zero jitter in the fronthaul by rate matching the ethernet frames with the eCPRI rate, and
a Sync DL buffer to enable simultaneous transmission from multiple ONUs forming a CoMP set so that all of them are synchronized in the downlink; and
said OLT;
wherein the OLT informs the ONUs with the differential amount of delay each ONU has to wait before transmitting it's data to the RRH and the OLT checks the fronthaul feasibility and slot allocation by interacting with the BBU pool through an interface.

### BRIEF DESCRIPTION OF THE DRAWINGS

FIG. 1: Proposed COMP downlink scheduling in 6G C-RAN highlighting the system modifications.

FIG. 2: Timing Diagram of COMP downlink scheduling in 6G.

FIG. 3: Modified MPCP protocol for facilitating CoMP in downlink.

FIG. 4: Illustration of Joint Optimization of wireless access and fronthaul scheduling

FIG. 5: Flow diagram of our proposed COMP scheduling considering fronthaul constraints.

FIG. 6. Total Network Throughput vs Number of users comparing Proposed with Baseline ONU scheduling Algorithm for 16 RRH Scenario

FIG. 7: Total Network Throughput vs Number of Optical Wavelengths (NA) and Time Slot (NT) in FH grid comparing Proposed with Baseline ONU scheduling Algorithm

### DESCRIPTION OF THE INVENTION

In this work the inventors have identified the dependency of wireless access data rate with the number of Front-Haul (FH) optical wavelengths in a Time Wavelength Division Multiplexing-Passive Optical Network (TWDM-PON) based Cloud-Radio Access Network (C-RAN) model for Beyond B5G or 6G networks. It is imperative to note that precise synchronization has to be maintained in the FH while transmitting copies of streams through Coordinated Multipoint Reception (COMP) Remote Radio Heads (RRHs) through the respective Optical Network Units (ONUs). To showcase the benefit of the proposed model with regards to the aforementioned-problem, the inventors have solved the problem of joint user association, resource block allocation and slot allocation optimization problem in JT COMP in a C-RAN model that maximizes the sum data rate of the network subject to wireless access and FH network constraints. We again highlight the necessary changes in the Multi Point Control Protocol (MPCP) such that precise synchronization is maintained. Moreover, the cycle time modification helps achieve the faithful reconstruction of signals at the ONU including the HARQ retransmissions. This suggests system-level modifications in the Media Access Control (MAC) layer.

### Explanation of Dependency of Fronthaul Constraint and Downlink Data Rate:

At the beginning of every polling cycle, the OLT, with the help of BBU (i.e., the OLT and BBU communicate through the control channel), decides which users are of an RRH (i.e., ONU) will be allocated with a resource block and at which wavelength and slot the ONU send the downstream data. While doing so, the OLT must ensure that if a COMP user is scheduled, all ONUs through which it transmits DS traffic should be assigned the same slot. The BBU then tries to allocate a resource block to the maximum number of scheduled users (decided by the previous step). While allocating a resource block, the BBU must ensure that the same resource block will be allocated to a COMP user in all RRHs through which it transmits US data. We can conclude that there is a dependency of resource block and time slot allocation in the CoMP scheduling.

### COMP Downlink Scheduling in TWDM-EPON Based C-RAN 6G Network:

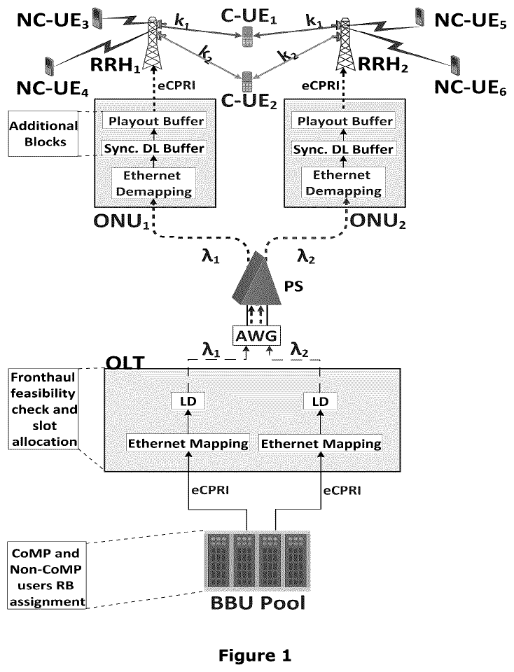

In this work, it is assumed that the functional split 7.2 which signifies that the network functions below the above split 7.2 are performed in the RRH unit/Distributed Unit (RU/DU) and the processed information is forwarded over the fronthaul towards the CU through PON network. It is considered that the RU and DU of the 6G network and the ONU of the PON are co-located to form a composite unit. In such a network scenario, the stringent delay requirements of a eCPRI/CPRI flow must be satisfied by the underlying PON network. It is assumed that the PON is used exclusively as a fronthaul network, which means all the ONUs of the PON are connected to an RU/DU of a gNodeB. The delay variation in the fronthaul network from ONU to Optical Line Terminal (OLT) depends on the propagation delay resulting from the difference in physical distances between them. We need to design playout buffers at the ONU as can be seen in FIG. 1. in order to match with the outgoing rate at the eCPRI.

The FIG. 1. shows the proposed architecture for downlink COMP transmission. The ONU has an additional block which contains a playout buffer to enable zero jitter in the fronthaul by rate matching the ethernet frames with the eCPRI rate. The Sync DL buffer is introduced to enable simultaneous transmission from multiple ONUs forming a COMP set so that all of them are synchronized in the downlink. The OLT informs the ONUs with the differential amount of delay each ONU has to wait before transmitting it's data to the RRH. The OLT checks the fronthaul feasibility and slot allocation by interacting with the BBU pool through an interface.

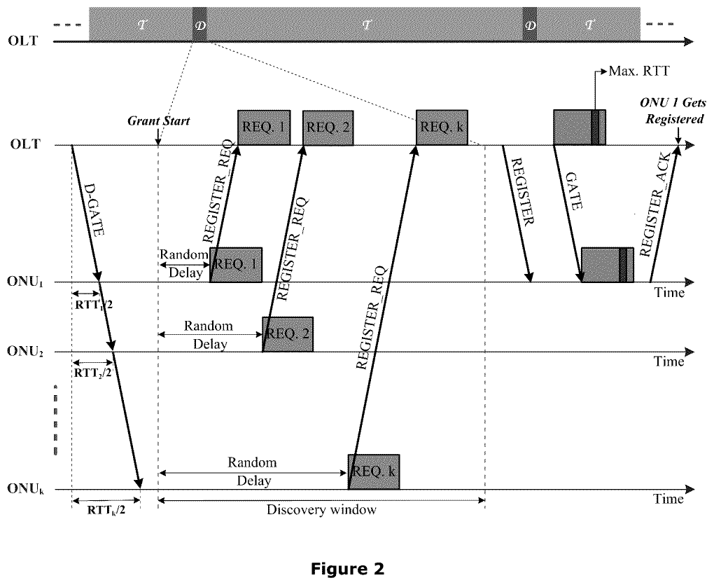

This work proposes an additional field in the GATE message in the existing MPCP protocol to ensure the synchronization of data at the user end in the downlink as illustrated in FIG. 2. This demands system level changes in the existing protocol in the MPMC layer of TWDM-EPON. The coordinated base stations would be scheduled in the same time slot and on the same resource block. Hence, playout buffers are designed in the ONU to align their outgoing rate with the incoming rate from the eCPRI/CPRI source. It is imperative to meet the stringent delay constraints stipulated by the eCPRI/CPRI. As a result, a received CPRI basic frame should not be queued for more than the specified delay threshold. This synchronization resulting from the modification in existing protocol would help SDN controllers to schedule coordinated multipoint users through different base stations connected through different wavelengths in the same time slot.

### ONU Scheduling in TWDM-EPON Under Stringent Delay Bound:

Here, the fixed slot and variable slot scheduling for ONUs in the downlink. There is a stringent requirement on delay bound at the MAC layer is discussed. If fix slot locations are allocated for all ONUs, then this can be avoided. However, there will be inefficiency in bandwidth utilization. Thus, variable slot scheduling is involved. It is shown that the worst-case delay in the timing diagram is for scenario2. A delay bound of twice the cycle time can be used. This gives us the flexibility to schedule any particular ONU at any slot in the cycle.

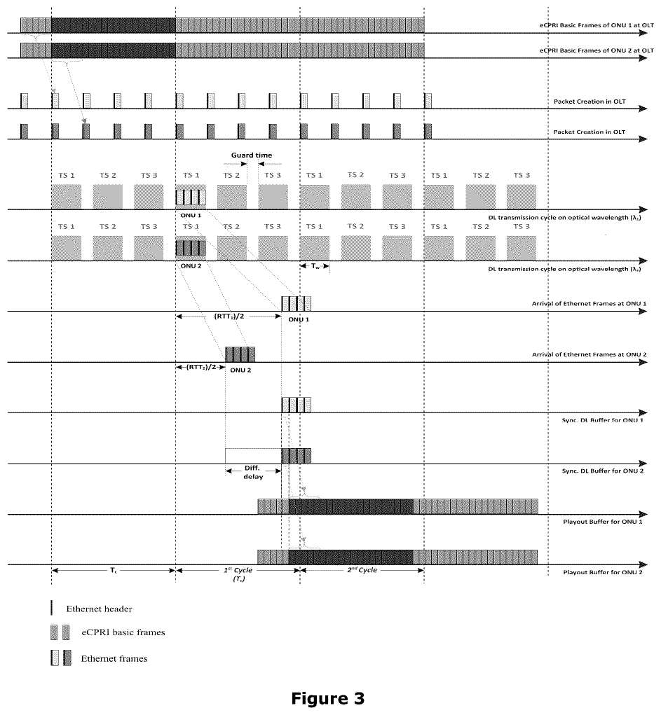

The scheduling phase starts after the auto-discovery process. In the ranging process, OLT takes a note of the Round Trip Time (RTT) from all the ONUs. Then, the maximum delay among all the ONUs is noted and is send across to all ONUs. The ONUs wait for the difference amount of time between the worst case delay and their respective synchronized time before initiating their data transmission in the downlink. This has been clearly depicted in FIG. 3.

Let us consider a COMP user, which receives its downstream (DS) data through ONU 1 and ONU 2 whose propagation delay, i.e., half of Round Trip Time (RTT), are RTT1 and RTT2 respectively. Now, as ONU 1 and ONU 2 are a user's COMP set, they have to be scheduled in the same time slot but on different wavelengths. Here, ONU 1 and ONU 2 are scheduled on T S1 of the 1st cycle but assigned different wavelengths (λ1) and (λ2) respectively. Since RTT1/2<RTT2/2, Ethernet packets of ONU 1 have to be buffered for a differential delay amount of time, i.e., RTT2/2-RTT1/2, at the ONU 1 end. Hence, they can be forwarded to their respective RRH simultaneously.

### Need of Joint Optimization:

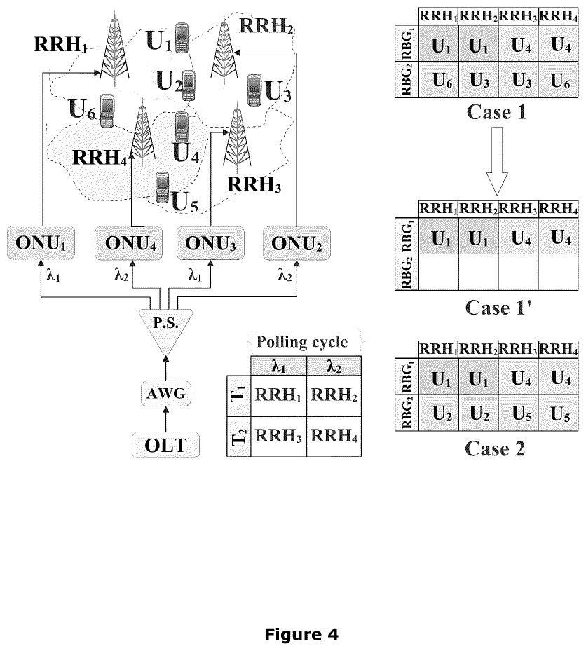

As dependency of downlink scheduling and fronthaul feasibility in a C-RAN based 6G networks is already discussed, joint optimization problem i.e. joint user association, sub-carrier (i.e. RBG) resource allocation and slot allocation needs to be addressed. FIG. 4 depicts scenarios where fronthaul and without fronthaul constraints are considered. Here, a COMP scenario in C-RAN consisting of a 2×2 grid of RRH is considered which is further connected to their respective ONUs, and ONUs are connected to OLT through a power splitter. The RRH1 and RRH2 are scheduled in time slot T1 with different wavelengths λ1 and λ2 respectively. Similarly, RRH3 and RRH4 are scheduled in time slot T2 with different wavelengths λ1 and λ2 respectively. It can be observed that considering fronthaul constraint gives us higher throughput than the random allocation. Hence, the wireless and fronthaul sections must be jointly optimized.

FIG. 4. demonstrates the need for joint optimization of wireless resources and fronthaul resources for COMP implementation in the downlink.

### Explanation of the Flow for the Joint Optimization Solution in the Downlink:

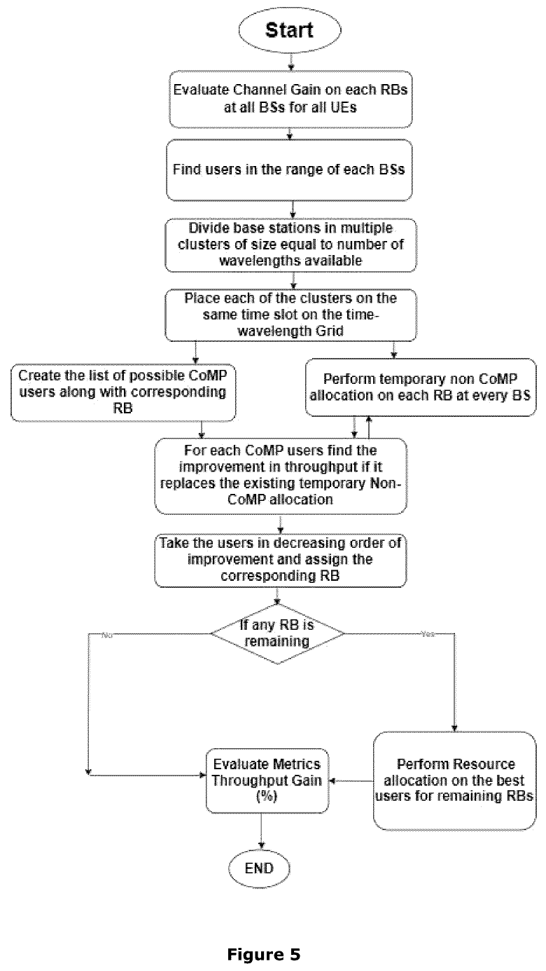

This work proposes a heuristic-based solution for the joint optimization of joint user association, sub-carrier (i.e. RBG) resource allocation and slot allocation in the downlink while considering the feasibility constraint in the fronthaul. The solution is provided in the flow diagram as shown in FIG. 5.

FIG. 5. is the joint scheduling algorithm for wireless resource blocks with fronthaul resources to maximize the total network throughput. This algorithm runs at the BBU pool by taking input of all channel conditions of users and available wavelengths from the OLT and the resultant scheduling information and user association is conveyed through the same interface from BBU to the OLT.

### Results Demonstrating the Benefit of Our Proposed Solution:

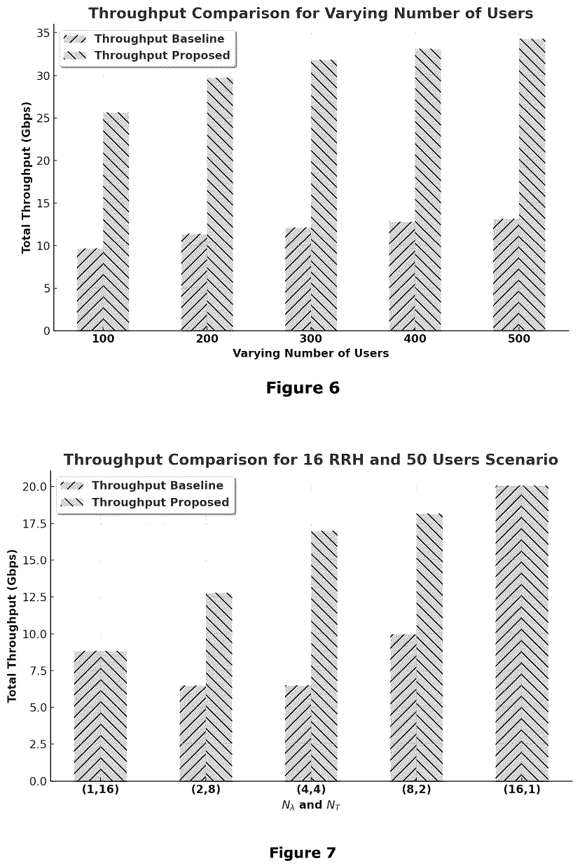

The inventors conducted extensive experiments to study the throughput gain of the proposed scheme, considering fronthaul feasibility. FIG. 6 shows that throughput increases as the number of users rises, with a fixed number of RRHs. Specifically, the figure examines total network throughput versus the number of users in a 16 RRH scenario, where the fronthaul grid has four wavelengths and time slots.

The results indicate that both the baseline and proposed algorithms see increased throughput with more users, but the proposed algorithm consistently outperforms the baseline. The proposed algorithm scales better, with the throughput gap widening from 100 to 500 users, suggesting it handles increased load more efficiently where the baseline starts to saturate. This improvement is likely due to enhanced coordination between wireless access and fronthaul scheduling, optimizing spectrum and wavelength use.

The superior performance of the proposed algorithm is attributed to the K-means clustering algorithm, which improves fronthaul scheduling efficiency and maximizes COMP set formation, boosting throughput. In contrast, the baseline algorithm randomly allocates ONUs, later checking COMP set feasibility, which significantly reduces estimated COMP sets and overall throughput.

The proposed algorithm achieves a significant throughput gain over the baseline, with a percentage increase from approximately 62.5% at 100 users to 61.5% at 500 users, demonstrating substantial network performance improvements.

FIG. 7 shows the throughput versus the number of wavelengths and time slots for both the proposed and random scheduling methods. In a 16 RRH scenario with 50 users, the throughput begins to saturate as the number of wavelengths increases. The percentage gain in throughput for the proposed algorithm over random scheduling decreases with more wavelengths, revealing the constraints in wavelength selection within our optimization formulation. The maximum gain occurs at lower wavelength counts, peaking at 4 wavelengths.

Furthermore, the proposed algorithm, which schedules COMP RRH clusters in the same time slot, achieves significantly higher throughput than random scheduling. Random scheduling does not account for COMP users and thus misses out on their potential benefits. With 4 wavelengths, the proposed algorithm shows a throughput gain of approximately 61% over random scheduling. When the wavelength count increases to 8, this gain drops to about 45.29%, indicating a decrease in relative performance improvement as the number of wavelengths increases.

What is claimed is:

1. A method for facilitating Coordinated Multipoint Transmission (COMP) involving joint scheduling of wireless access and Time Wavelength Division Multiplexing-Passive Optical Network (TWDM-PON) based fronthaul for COMP joint transmission comprising:
identifying dependency of wireless access data rate with the number of Front-Haul (FH) optical wavelengths in the TWDM-PON based Cloud-Radio Access Network (C-RAN);
maintaining synchronization in the FH while transmitting copies of streams through Coordinated Multipoint Reception (COMP) Remote Radio Heads (RRHs) through respective Optical Network Units (ONUs) by necessary changes in the Multi Point Control Protocol (MPCP);
cycle time modification to achieve faithful reconstruction of signals at the ONU including HARQ retransmissions through modifications in Media Access Control (MAC) layer.

2. The method as claimed in claim 1, wherein the identification of the dependency of wireless access data rate with the number of Front-Haul (FH) optical wavelengths in the TWDM-PON based Cloud-Radio Access Network (C-RAN) model includes involving communication operating between OLT (Optical Line Terminal) and BBU (Base Band Unit) through a control channel at beginning of every polling cycle to decide which users are of an RRH (i.e., ONU) will be allocated with a resource block and at which wavelength and slot the ONU send the downstream data, whereby the OLT ensure that if a user is scheduled, all the ONUs through which it transmits downstream (DS) traffic should be assigned the same slot;
allocating the resource block to the maximum number of scheduled users by the BBU ensuring the same resource block will be allocated to the user in all RRHs through which it transmits downstream (DS) data.

3. The method as claimed in claim 2, wherein the changes in the MPCP with COMP Downlink Scheduling in TWDM-EPON based C-RAN 6G Network includes involving playout buffers at the ONU in order to match with the outgoing rate at eCPRI. providing an additional field in GATE message in existing MPCP protocol to ensure the synchronization of data at the user end in the downlink; wherein the playout buffers in the ONU align their outgoing rate with the incoming rate from the eCPRI/CPRI source resulting a received CPRI basic frame should not be queued for more than the specified delay threshold and a synchronization which help SDN controllers to schedule coordinated multipoint users through different base stations connected through different wavelengths in the same time slot.

4. The method as claimed in claim 1, wherein the modification in Media Access Control (MAC) layer includes providing variable slot scheduling for the ONUs in the downlink to meet stringent requirement on delay bound at the MAC layer involving the OLT to takes a note of the Round Trip Time (RTT) from all the ONUs and noting the maximum delay among all the ONUs which is sent across to all ONUs such as that the ONUs wait for the difference amount of time between worst case delay and their respective synchronized time before initiating their data transmission in the downlink.

5. The method as claimed in claim 1, is adapted for joint user association, sub-carrier (i.e. RBG) resource allocation and slot allocation through jointly optimized operation.

6. A system implementing method for facilitating the Coordinated Multipoint Transmission (COMP) involving joint scheduling of wireless access and Time Wavelength Division Multiplexing-Passive Optical Network (TWDM-PON) based fronthaul for COMP joint transmission as claimed in claim 1 comprising:
said ONUs each having
a playout buffer to enable zero jitter in the fronthaul by rate matching the ethernet frames with the eCPRI rate, and
a Sync DL buffer to enable simultaneous transmission from multiple ONUs forming a COMP set so that all of them are synchronized in the downlink; and
said OLT;
wherein the OLT informs the ONUs with the differential amount of delay each ONU has to wait before transmitting it's data to the RRH and the OLT checks the fronthaul feasibility and slot allocation by interacting with the BBU pool through an interface.
